(19) United States
(12) Patent Application Publication
(10) Pub. No.: US 2026/0302625 A1
(43) Pub. Date: Oct. 1, 2026

(54) PATCH ANTENNA MODULE AND MOBILE ELECTRONIC DEVICE

(71) Applicant: INPAQ TECHNOLOGY CO., LTD., MIAOLI COUNTY (TW)

(72) Inventors: Yang-Hsin Fan, Hsinchu County (TW); TA-FU CHENG, MIAOLI COUNTY (TW)

(21) Appl. No.: 19/215,353

(22) Filed: May 22, 2025

(30) Foreign Application Priority Data
Mar. 31, 2025 (TW) 114112229

(51) Int. Cl. H01Q 9/04; H01Q 1/22; H01Q 1/48; H01Q 5/30

(52) U.S. Cl. CPC H01Q 9/0414; H01Q 1/22; H01Q 1/48; H01Q 5/30

(57) ABSTRACT

A patch antenna module and a mobile electronic device. The patch antenna module includes an antenna layout carrying structure, a planar antenna layout structure, an antenna positioning structure and an antenna frequency adjustment structure. The antenna positioning structure is disposed on the planar antenna layout structure. The antenna frequency adjustment structure is disposed on the antenna positioning structure. The planar antenna layout structure is coplanarly disposed on the antenna layout carrying structure. The antenna positioning structure is configured to partially cover the planar antenna layout structure. The antenna frequency adjustment structure is configured to partially cover the planar antenna layout structure. The antenna frequency adjustment structure is positioned on the planar antenna layout structure through the antenna positioning structure. The antenna frequency adjustment structure includes an inner surrounding structure disposed on the antenna positioning structure and an outer surrounding structure separated from the antenna positioning structure.

### CROSS-REFERENCE TO RELATED PATENT APPLICATION

This application claims the benefit of priority to Taiwan Patent Application No. 114112229, filed on Mar. 31, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a patch antenna module and a mobile electronic device, and more particularly to a top-covered-type flat antenna module and a mobile electronic device configured to use the top-covered-type flat antenna module.

### BACKGROUND OF THE DISCLOSURE

In the related art, a patch antenna is generally formed by stacking two antenna structures. However, since each antenna structure needs to be supported by a ceramic substrate, the patch antenna provided by the related art still has room for improvement.

### SUMMARY OF THE DISCLOSURE

In response to the above-referenced technical inadequacy, the present disclosure provides a patch antenna module and a mobile electronic device.

In order to solve the above-mentioned problems, one of the technical aspects adopted by the present disclosure is to provide a patch antenna module, which includes an antenna layout carrying structure, a planar antenna layout structure, an antenna positioning structure and an antenna frequency adjustment structure. The planar antenna layout structure is disposed on the antenna layout carrying structure. The antenna positioning structure is disposed on the planar antenna layout structure. The antenna frequency adjustment structure is disposed on the antenna positioning structure. The planar antenna layout structure is configured to be coplanarly disposed on the antenna layout carrying structure. The antenna positioning structure is configured to partially cover the planar antenna layout structure. The antenna frequency adjustment structure is configured to partially cover the planar antenna layout structure. The antenna frequency adjustment structure is positioned on the planar antenna layout structure through the antenna positioning structure. The antenna frequency adjustment structure includes an inner surrounding structure disposed on the antenna positioning structure and an outer surrounding structure being surroundingly connected to the inner surrounding structure and being separated from the antenna positioning structure.

In order to solve the above-mentioned problems, another one of the technical aspects adopted by the present disclosure is to provide a mobile electronic device configured to use a patch antenna module, in which the patch antenna module includes an antenna layout carrying structure, a planar antenna layout structure, an antenna positioning structure and an antenna frequency adjustment structure. The planar antenna layout structure is disposed on the antenna layout carrying structure. The antenna positioning structure is disposed on the planar antenna layout structure. The antenna frequency adjustment structure is disposed on the antenna positioning structure. The planar antenna layout structure is configured to be coplanarly disposed on the antenna layout carrying structure. The antenna positioning structure is configured to partially cover the planar antenna layout structure. The antenna frequency adjustment structure is configured to partially cover the planar antenna layout structure. The antenna frequency adjustment structure is positioned on the planar antenna layout structure through the antenna positioning structure. The antenna frequency adjustment structure includes an inner surrounding structure disposed on the antenna positioning structure and an outer surrounding structure being surroundingly connected to the inner surrounding structure and being separated from the antenna positioning structure.

Therefore, in the patch antenna module and the mobile electronic device provided by the present disclosure, by virtue of “the planar antenna layout structure being configured to be coplanarly disposed on the antenna layout carrying structure,” “the antenna positioning structure being configured to partially cover the planar antenna layout structure,” “the antenna frequency adjustment structure being configured to partially cover the planar antenna layout structure,” “the antenna frequency adjustment structure being positioned on the planar antenna layout structure through the antenna positioning structure” and “the antenna frequency adjustment structure including an inner surrounding structure disposed on the antenna positioning structure and an outer surrounding structure that is surroundingly connected to the inner surrounding structure and separated from the antenna positioning structure,” the inner surrounding antenna structure of the planar antenna layout structure can be configured to be applied to a first antenna operating frequency band, and the outer surrounding antenna structure of the planar antenna layout structure can be configured to be applied to a second antenna operating frequency band.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a top-covered-type flat antenna module using a first antenna frequency adjustment structure provided by a first embodiment of the present disclosure;

FIG. 2 is a schematic cross-sectional view taken along line II-II of FIG. 1;

FIG. 3 is a schematic perspective view of the top-covered-type flat antenna module using a second antenna frequency adjustment structure provided by the first embodiment of the present disclosure;

FIG. 4 is a schematic cross-sectional view taken along line IV-IV of FIG. 3;

FIG. 5 is a schematic perspective view of the top-covered-type flat antenna module using the second antenna frequency adjustment structure provided by a second embodiment of the present disclosure;

FIG. 6 is a schematic cross-sectional view taken along line VI-VI of FIG. 5;

FIG. 7 is a schematic cross-sectional view taken along line VII-VII of FIG. 5;

FIG. 8 is a schematic cross-sectional view of the top-covered-type flat antenna module using the second antenna frequency adjustment structure provided by a third embodiment of the present disclosure;

FIG. 9 is a schematic cross-sectional view of the top-covered-type flat antenna module using the second antenna frequency adjustment structure provided by a fourth embodiment of the present disclosure;

FIG. 10 is a schematic perspective view of the top-covered-type flat antenna module using the second antenna frequency adjustment structure provided by a fifth embodiment of the present disclosure;

FIG. 11 is a schematic cross-sectional view of the top-covered-type flat antenna module using the second antenna frequency adjustment structure according to a sixth embodiment of the present disclosure; and

FIG. 12 is a functional block diagram of a mobile electronic device using the top-covered-type flat antenna module according to a seventh embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

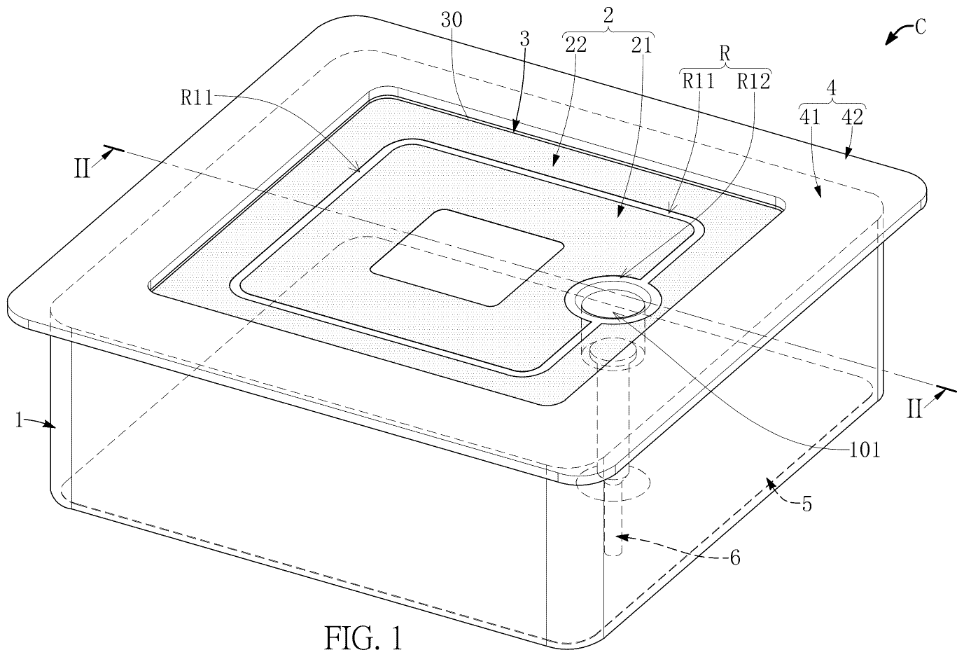

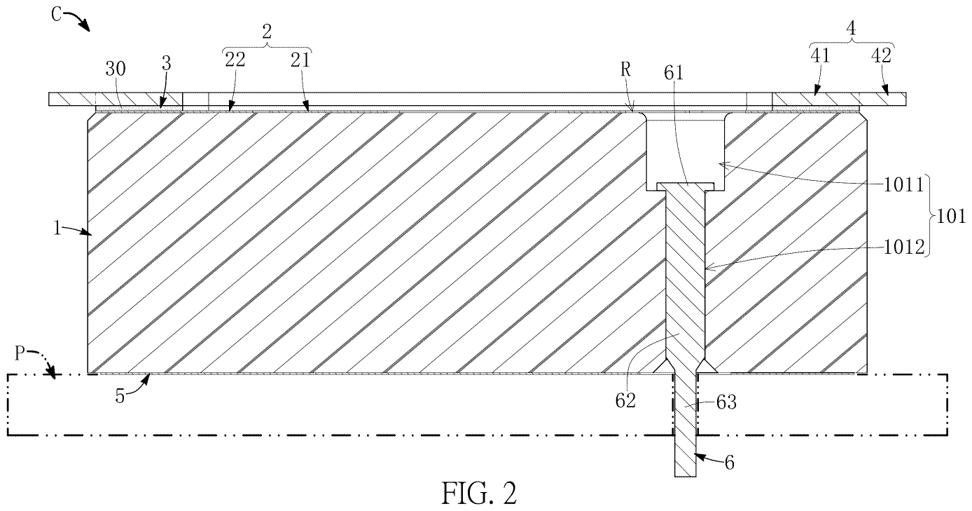

Referring to FIG. 1 and FIG. 2, a first embodiment of the present disclosure provides a patch antenna module C (or a top-covered-type flat antenna module), which may include an antenna layout carrying structure 1 (or an antenna pattern supporting structure), a planar antenna layout structure 2, an antenna positioning structure 3 (or an antenna dedicated positioning structure) and an antenna frequency adjustment structure 4 (or a first antenna frequency adjustment structure). More particularly, the planar antenna layout structure 2 can be disposed on the antenna layout carrying structure 1, the antenna positioning structure 3 can be disposed on the planar antenna layout structure 2, and the antenna frequency adjustment structure 4 can be disposed on the antenna positioning structure 3. For example, according to different requirements, the patch antenna module C can be configured to be disposed on a circuit substrate P (or any type of carrier substrate), and the patch antenna module C can be made of conductive materials except for the antenna layout carrying structure 1. However, the aforementioned details are disclosed for exemplary purposes only, and are not meant to limit the scope of the present disclosure.

Firstly, referring to FIG. 1 and FIG. 2, the planar antenna layout structure 2 can be configured to be coplanarly disposed on the antenna layout carrying structure 1. For example, the antenna layout carrying structure 1 may have a first through hole 101 (or a first through channel), and the antenna layout carrying structure 1 can be made of ceramic material, plastic material or any type of insulating material. Moreover, a central penetration portion (or a central through portion) of the antenna layout carrying structure 1 can be configured as a solid portion or a hollow portion (or a through-hole portion). When the central penetration portion of the antenna layout carrying structure 1 can be configured as a solid portion (as shown in FIG. 1 and FIG. 2), the entire antenna layout carrying structure 1 can be a solid body. When the central penetration portion of the antenna layout carrying structure 1 can be configured as a hollow portion (not shown), the weight of the antenna layout carrying structure 1 can be effectively reduced. In addition, the antenna layout carrying structure 1 can be configured as a single insulating carrier substrate (as shown in FIG. 1 and FIG. 2) that can be integrally formed or a stacked-type carrier substrate assembly (not shown) that can be formed by stacking at least two insulating carrier substrates. However, the aforementioned details are disclosed for exemplary purposes only, and are not meant to limit the scope of the present disclosure.

More particularly, referring to FIG. 1 and FIG. 2, the planar antenna layout structure 2 may include an inner surrounding antenna structure 21 (or an inner surrounding electrode structure) and an outer surrounding antenna structure 22 (or an outer surrounding electrode structure). In addition, the inner surrounding antenna structure 21 and the outer surrounding antenna structure 22 can be coplanarly disposed on a top side of the antenna layout carrying structure 1, and the inner surrounding antenna structure 21 can be surrounded by the outer surrounding antenna structure 22, so that the patch antenna module C can achieve the advantages of reducing volume (i.e., reduced size), reducing weight (i.e., light weight) and improving antenna signal transmission performance (or antenna operation characteristics). More particularly, a surrounding non-antenna area R (such as an area without radiating structure or electrode structure) is formed between the inner surrounding antenna structure 21 and the outer surrounding antenna structure 22 so as to separate the inner surrounding antenna structure 21 and the outer surrounding antenna structure 22 from each other and to partially expose an upper surface of the antenna layout carrying structure 1. For example, the surrounding non-antenna area R (or the surrounding antenna-free area) may have at least one unoccupied line area R11 (such as a plurality of straight-line clearance areas as an example for explanation shown in FIG. 1) and at least one unoccupied opening area R12 (such as an opening clearance area that may be offset toward the center position or close to the center position, so that the opening clearance area may deviate from the unoccupied line area R11) connected to two opposite sides of the at least one unoccupied line area R11, and a diameter of the at least one unoccupied opening area R12 can be greater than a width of the at least one unoccupied line area R11. Therefore, the antenna characteristics of the patch antenna module C provided by the present disclosure can be adjusted through the arrangement of the at least one unoccupied line area R11 and the at least one unoccupied opening area R12 of the surrounding non-antenna area R. However, the aforementioned details are disclosed for exemplary purposes only, and are not meant to limit the scope of the present disclosure.

It should be noted that as shown in FIG. 1, the inner surrounding antenna structure 21 can be configured to be applied to a first antenna operating frequency band (or the antenna operating frequency band of a first antenna), the outer surrounding antenna structure 22 can be configured to be applied to a second antenna operating frequency band (or the antenna operating frequency band of a second antenna), and the first antenna operating frequency band can be greater than the second antenna operating frequency band. For example, the inner surrounding antenna structure 21 and the outer surrounding antenna structure 22 can be applied to receive signals from the global satellite positioning system (GPS), so that the patch antenna module C can be configured as a GPS (Global Positioning System) antenna. However, the aforementioned details are disclosed for exemplary purposes only, and are not meant to limit the scope of the present disclosure.

Moreover, referring to FIG. 1 and FIG. 2, the patch antenna module C may further include a bottom grounding structure 5 (or a bottom electrode structure) and a first signal feeding structure 6. More particularly, the bottom grounding structure 5 can be disposed on a bottom side of the antenna layout carrying structure 1, the first signal feeding structure 6 can be disposed on the antenna layout carrying structure 1 and can pass through the antenna layout carrying structure 1, and the first signal feeding structure 6 can be located between the inner surrounding antenna structure 21 and the outer surrounding antenna structure 22 and can be separated from the bottom grounding structure 5. In addition, a portion of the first signal feeding structure 6 can be embedded in the first through hole 101 of the antenna layout carrying structure 1, and another portion of the first signal feeding structure 6 can be exposed outside the first through hole 101 of the antenna layout carrying structure 1.

More particularly, as shown in FIG. 2, the first through hole 101 of the antenna layout carrying structure 1 may have a first top through-hole portion 1011 and a first bottom through-hole portion 1012 communicated with the first top through-hole portion 1011, and an aperture of the first top through-hole portion 1011 can be larger than an aperture of the first bottom through-hole portion 1012. Moreover, the first signal feeding structure 6 may include a first top position-limiting portion 61 (or a first top cap portion), a first embedded extension portion 62 connected to the first top position-limiting portion 61, and a first bottom exposed portion 63 connected to the first embedded extension portion 62. In addition, the first top position-limiting portion 61 can be disposed inside the first top through-hole portion 1011, the first embedded extension portion 62 can be disposed inside the first bottom through-hole portion 1012, and the first bottom exposed portion 63 can be exposed outside the first bottom through-hole portion 1012 (or the first bottom exposed portion 63 may be exposed from the bottom surface of the antenna layout carrying structure 1).

It should be noted that as shown in FIG. 2, a first vertical distance between the first top position-limiting portion 61 of the first signal feeding structure 6 and the inner surrounding antenna structure 21 (or the outer surrounding antenna structure 22) can be greater than a first horizontal distance between the first top position-limiting portion 61 of the first signal feeding structure 6 and the inner surrounding antenna structure 21 (or the outer surrounding antenna structure 22). That is to say, since the first top position-limiting portion 61 of the first signal feeding structure 6 can be sunk into (or embedded in) the first top through-hole portion 1011 of the first through hole 101 and be away from the inner surrounding antenna structure 21 (or the outer surrounding antenna structure 22) by a predetermined distance in order to achieve impedance matching, so that the inner surrounding antenna structure 21 and the outer surrounding antenna structure 22 do not need to be very far away from the first through hole 101 in the horizontal direction (that is to say, a first horizontal distance between the first top position-limiting portion 61 of the first signal feeding structure 6 and the inner surrounding antenna structure 21 or the outer surrounding antenna structure 22 can be reduced), which can increase the horizontal area (or the horizontal extension area) of the inner surrounding antenna structure 21 and the outer surrounding antenna structure 22. In addition, the impedance matching of the patch antenna module C provided by the present disclosure can be adjusted according to the depth of the first top position-limiting portion 61 of the first signal feeding structure 6 sunk into (or embedded in) the first top through-hole portion 1011 of the first through hole 101.

Furthermore, referring to FIG. 1 and FIG. 2, the antenna positioning structure 3 can be configured to partially cover the planar antenna layout structure 2, and the antenna frequency adjustment structure 4 can be configured to partially (or contactlessly) cover the planar antenna layout structure 2. More particularly, the antenna frequency adjustment structure 4 can be positioned on the planar antenna layout structure 2 through the antenna positioning structure 3, and the antenna frequency adjustment structure 4 may include an inner surrounding structure 41 (such as a first continuous surrounding plate) disposed on the antenna positioning structure 3 and an outer surrounding structure 42 (such as a second continuous surrounding plate) being surroundingly connected to the inner surrounding structure 41 and being separated from the antenna positioning structure 3. For example, the antenna positioning structure 3 can be configured as a tin-containing material layer, a conductive adhesive layer (or an insulating adhesive layer) or any adhesive material layer (or the antenna positioning structure 3 can be configured as a conductive adhesive layer 30 between the inner surrounding structure 41 and the outer surrounding antenna structure 22 of the planar antenna layout structure 2), and the antenna frequency adjustment structure 4 can be configured as a top metal cover plate located at a top position of the patch antenna module C. In addition, the thickness of the planar antenna layout structure 2 may be between 5 μm and 20 μm (such as any positive integer between 5 μm and 20 μm), the thickness of the antenna positioning structure 3 may be between 50 μm and 200 μm (such as any positive integer between 50 μm and 200 μm), and the thickness of the antenna frequency adjustment structure 4 may be between 200 μm and 400 μm (such as any positive integer between 200 μm and 400 μm). However, the aforementioned details are disclosed for exemplary purposes only, and are not meant to limit the scope of the present disclosure.

It should be noted that as shown in FIG. 2, a vertical projection of the inner surrounding structure 41 of the antenna frequency adjustment structure 4 can completely fall on the antenna positioning structure 3 and the planar antenna layout structure 2, so that a bottom side of the inner surrounding structure 41 of the antenna frequency adjustment structure 4 can be completely covered. In addition, a vertical projection of the outer surrounding structure 42 of the antenna frequency adjustment structure 4 does not completely (or partially) fall on the antenna positioning structure 3 and the planar antenna layout structure 2, so that a bottom side of the outer surrounding structure 42 of the antenna frequency adjustment structure 4 cannot be covered and exposed outside (or the bottom side of the outer surrounding structure 42 of the antenna frequency adjustment structure 4 does not contact the antenna positioning structure 3 at all).

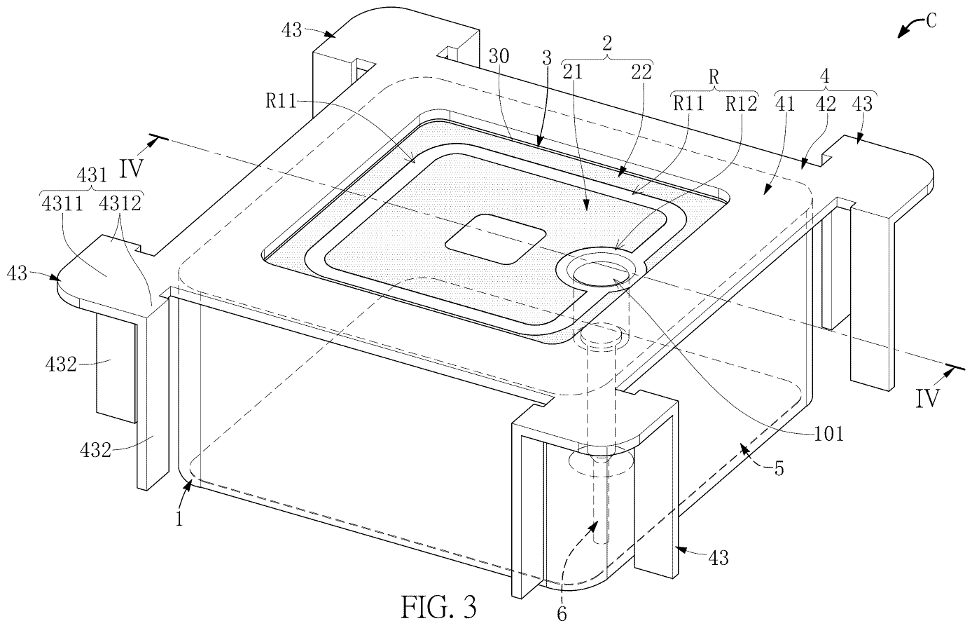

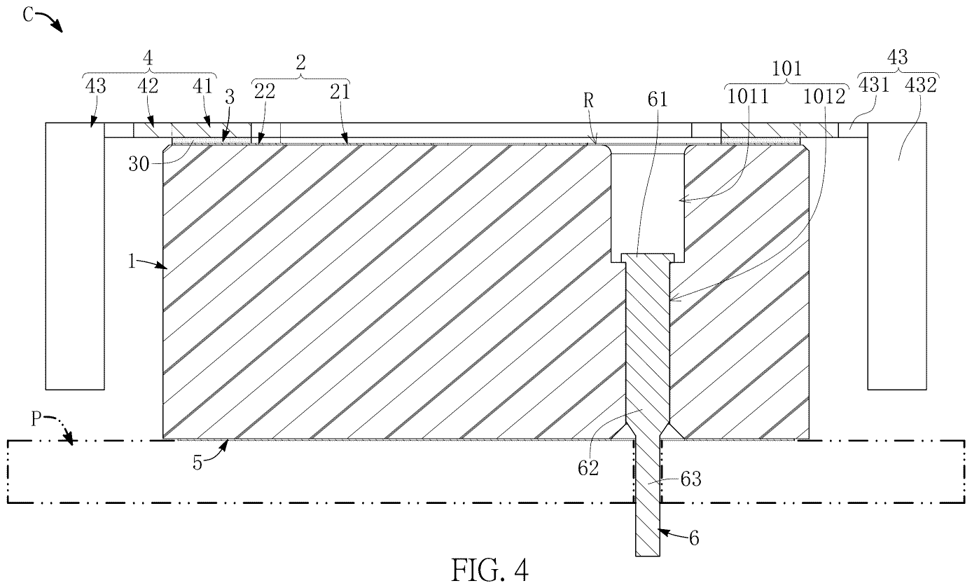

It should be noted that as shown in FIG. 3 and FIG. 4, the patch antenna module C provided by the first embodiment of the present disclosure can also be replaced by another antenna frequency adjustment structure 4 (or the second antenna frequency adjustment structure). More particularly, the antenna frequency adjustment structure 4 may further include a plurality of outer extension structures 43 extending outward from the outer surrounding structure 42 and being separated from the antenna positioning structure 3. For example, the plurality of outer extension structures 43 can be respectively arranged at the plurality of corners of the antenna frequency adjustment structure 4 and arranged symmetrically with each other, and each of the outer extension structures 43 may include a horizontal extension section 431 extending horizontally outward from the outer surrounding structure 42 and two vertical extension sections 432 extending vertically downward from the horizontal extension section 431 (the two vertical extension sections 432 may also be arranged symmetrically to each other). Moreover, a height of each of the vertical extension sections 432 of each of the outer extension structures 43 can be less than a height of the antenna layout carrying structure 1, so that each of the vertical extension sections 432 of each of the outer extension structures 43 can be in a suspended state, thereby avoiding contact with the circuit substrate P. In addition, the horizontal extension section 431 of each of the outer extension structures 43 may have a horizontal main extension portion 4311 connected to a corner of the outer surrounding structure 42 and two horizontal auxiliary extension portions 4312 extending from two opposite sides of the horizontal main extension portion 4311 respectively, and the two vertical extension sections 432 of each of the outer extension structures 43 can extend vertically downward from the two horizontal auxiliary extension portions 4312 of a corresponding one of the horizontal extension sections 431 respectively. However, the aforementioned details are disclosed for exemplary purposes only, and are not meant to limit the scope of the present disclosure.

### Second Embodiment

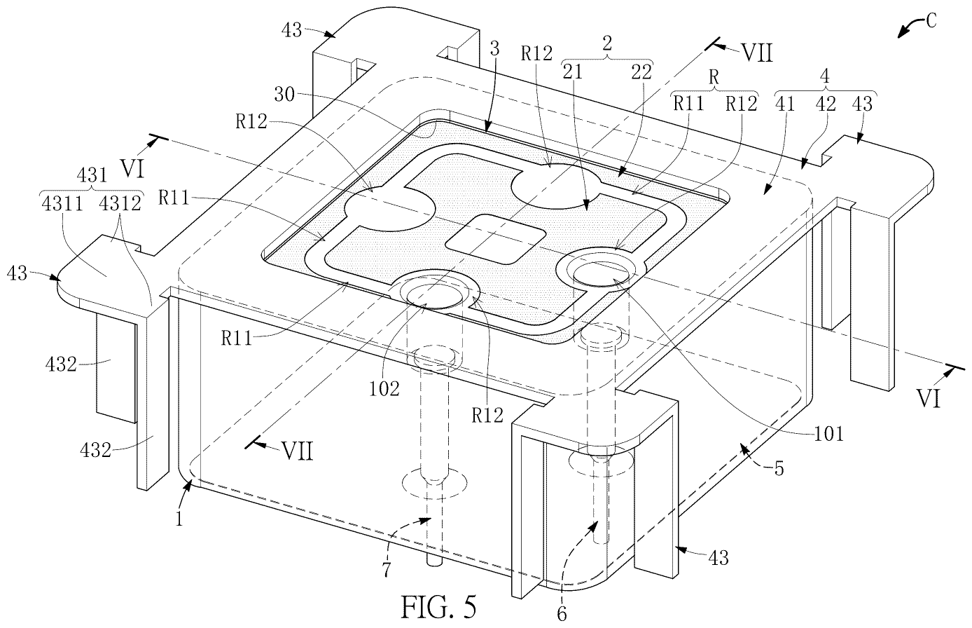

Referring to FIG. 5 to FIG. 7, a second embodiment of the present disclosure provides a patch antenna module C, which may include an antenna layout carrying structure 1, a planar antenna layout structure 2, an antenna positioning structure 3, an antenna frequency adjustment structure 4 (or a second antenna frequency adjustment structure), a bottom grounding structure 5 and a first signal feeding structure 6. By comparing FIG. 5 with FIG. 3, the main difference between the second embodiment and the first embodiment is as follows: in the second embodiment, the patch antenna module C may further include a second signal feeding structure 7, and the patch antenna module C can achieve dual-frequency circular polarization characteristics (such as left-hand circular polarization or right-hand circular polarization) through the cooperation of the first signal feeding structure 6 and the second signal feeding structure 7.

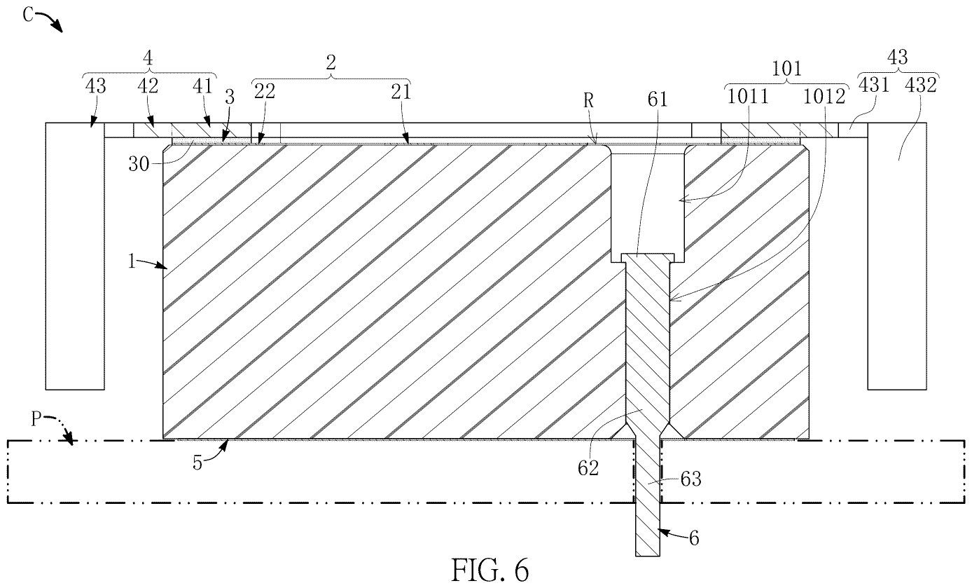

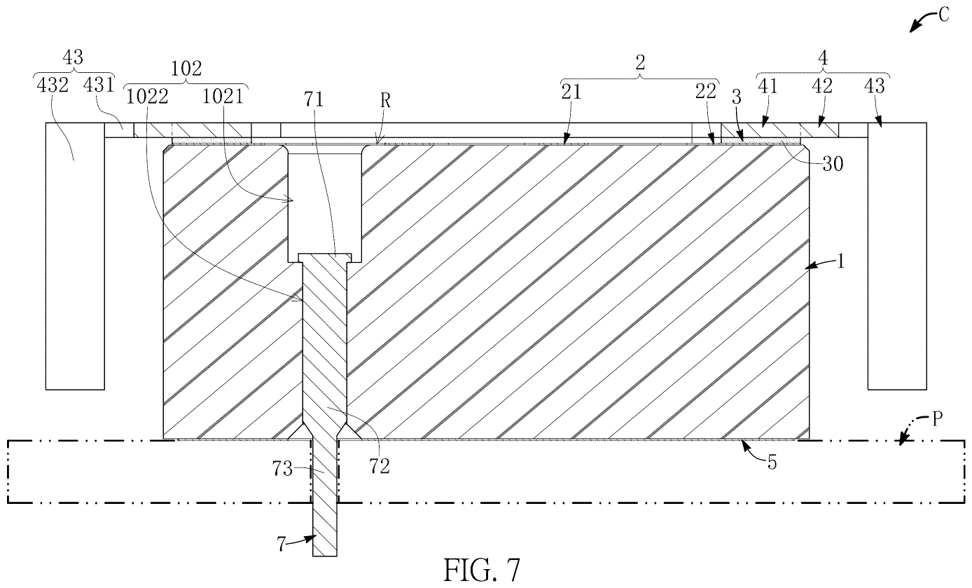

More particularly, referring to FIG. 5, FIG. 6 and FIG. 7, the second signal feeding structure 7 can be disposed on the antenna layout carrying structure 1 and can pass through the antenna layout carrying structure 1, and the second signal feeding structure 7 can be located between the inner surrounding antenna structure 21 and the outer surrounding antenna structure 22 and can be separated from the bottom grounding structure 5. In addition, the antenna layout carrying structure 1 may have a second through hole 102, a portion of the second signal feeding structure 7 can be embedded in the second through hole 102 of the antenna layout carrying structure 1, and another portion of the second signal feeding structure 7 can be exposed outside the second through hole 102 of the antenna layout carrying structure 1. It should be noted that the first signal feeding structure 6 and the second signal feeding structure 7 can be arranged at an angle of 90 degrees from each other relative to a central penetration portion of the antenna layout carrying structure 1.

More particularly, as shown in FIG. 7, the second through hole 102 of the antenna layout carrying structure 1 may have a second top through-hole portion 1021 and a second bottom through-hole portion 1022 communicated with the second top through-hole portion 1021, and an aperture of the second top through-hole portion 1021 can be larger than an aperture of the second bottom through-hole portion 1022. Moreover, the second signal feeding structure 7 may include a second top position-limiting portion 71 (or a second top cap portion), a second embedded extension portion 72 connected to the second top position-limiting portion 71, and a second bottom exposed portion 73 connected to the second embedded extension portion 72. In addition, the second top position-limiting portion 71 can be disposed inside the second top through-hole portion 1021, the second embedded extension portion 72 can be disposed inside the second bottom through-hole portion 1022, and the second bottom exposed portion 73 can be exposed outside the second bottom through-hole portion 1022 (or the second bottom exposed portion 73 may be exposed from the bottom surface of the antenna layout carrying structure 1).

It should be noted that as shown in FIG. 7, a second vertical distance between the second top position-limiting portion 71 of the second signal feeding structure 7 and the inner surrounding antenna structure 21 (or the outer surrounding antenna structure 22) can be greater than a second horizontal distance between the second top position-limiting portion 71 of the second signal feeding structure 7 and the inner surrounding antenna structure 21 (or the outer surrounding antenna structure 22). That is to say, since the second top position-limiting portion 71 of the second signal feeding structure 7 can be sunk into (or embedded in) the second top through-hole portion 1021 of the second through hole 102 and be away from the inner surrounding antenna structure 21 (or the outer surrounding antenna structure 22) by a predetermined distance in order to achieve impedance matching, so that the inner surrounding antenna structure 21 and the outer surrounding antenna structure 22 do not need to be very far away from the second through hole 102 in the horizontal direction (that is to say, a second horizontal distance between the second top position-limiting portion 71 of the second signal feeding structure 7 and the inner surrounding antenna structure 21 or the outer surrounding antenna structure 22 can be reduced), which can increase the horizontal area (or the horizontal extension area) of the inner surrounding antenna structure 21 and the outer surrounding antenna structure 22.

It should be noted that as shown in FIG. 5, the surrounding non-antenna area R may have a plurality of unoccupied line areas R11 and a plurality of unoccupied opening areas R12, each of the unoccupied opening areas R12 is connected between two adjacent unoccupied line areas R11, and a diameter of the unoccupied opening area R12 can be greater than a width of the unoccupied line area R11. Therefore, the antenna characteristics of the patch antenna module C provided by the present disclosure can be adjusted through the arrangement of the plurality of unoccupied line areas R11 and the plurality of unoccupied opening areas R12 of the surrounding non-antenna area R.

It should be noted that the impedance matching of the patch antenna module C provided by the present disclosure can be adjusted according to “the depth of the first top position-limiting portion 61 of the first signal feeding structure 6 sunk into (or embedded in) the first top through-hole portion 1011 of the first through hole 101” and “the depth of the second top position-limiting portion 71 of the second signal feeding structure 7 sunk into (or embedded in) the second top through-hole portion 1021 of the second through hole 102.” In addition, the present disclosure can also compensate for “the asymmetry of the electrode surface caused by the first through hole 101 and the second through hole 102” through the plurality of unoccupied opening areas R12, so that the patch antenna module C can achieve a low axial ratio characteristic.

### Third Embodiment

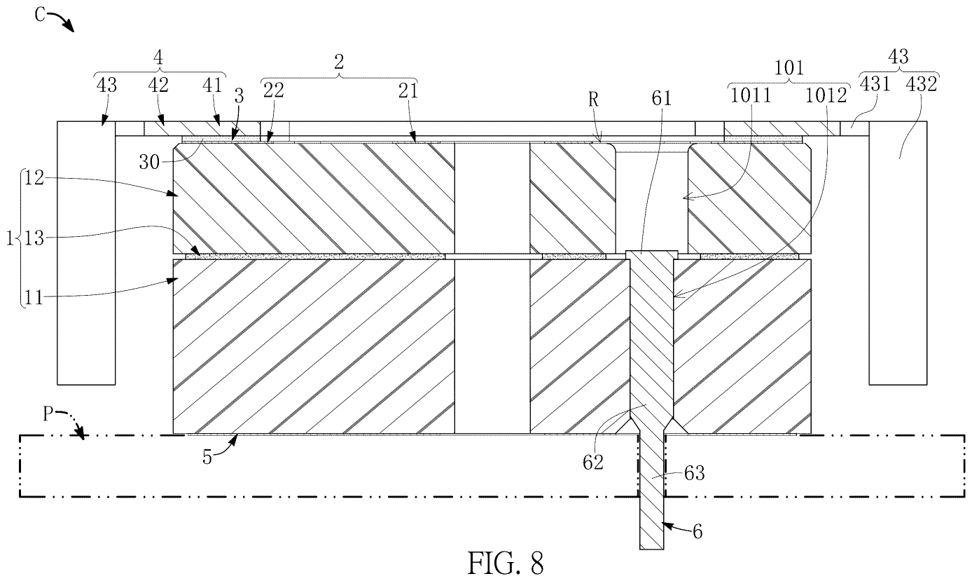

Referring to FIG. 8, a third embodiment of the present disclosure provides a patch antenna module C, which may include an antenna layout carrying structure 1, a planar antenna layout structure 2, an antenna positioning structure 3, an antenna frequency adjustment structure 4 (or a second antenna frequency adjustment structure), a bottom grounding structure 5, a first signal feeding structure 6 and a second signal feeding structure 7. By comparing FIG. 8 with FIG. 6, the main difference between the third embodiment and the second embodiment is as follows: in the third embodiment, the antenna layout carrying structure 1 can be configured as a stacked-type carrier substrate assembly.

More particularly, as shown in FIG. 8, when the antenna layout carrying structure 1 can be configured as the stacked-type carrier substrate assembly, the stacked-type carrier substrate assembly may at least include a first insulating carrier substrate 11, a second insulating carrier substrate 12, and an insulating adhesive layer 13 connected between the first insulating carrier substrate 11 and the second insulating carrier substrate 12. In addition, the second insulating carrier substrate 12 can be stacked on the first insulating carrier substrate 11 through the insulating adhesive layer 13, so that an outer surrounding surface of the first insulating carrier substrate 11 can be exposed outside the second insulating carrier substrate 12. That is to say, according to different requirements, the antenna layout carrying structure 1 can be configured as a single insulating carrier substrate (as shown in the first and second embodiments), or a stacked-type carrier substrate assembly formed by at least stacking a first insulating carrier substrate 11 and a second insulating carrier substrate 12 (as shown in the third embodiment).

### Fourth Embodiment

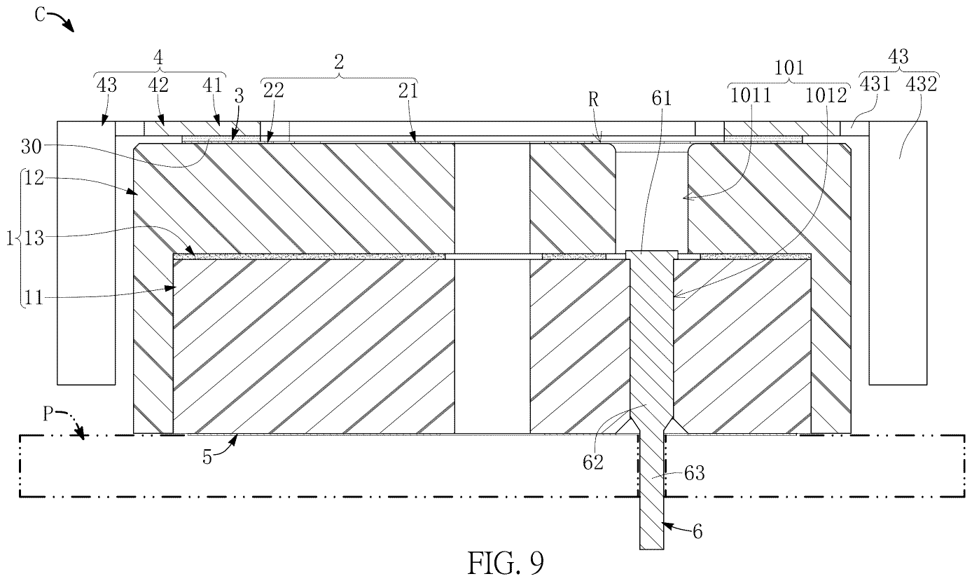

Referring to FIG. 9, a fourth embodiment of the present disclosure provides a patch antenna module C, which may include an antenna layout carrying structure 1, a planar antenna layout structure 2, an antenna positioning structure 3, an antenna frequency adjustment structure 4 (or a second antenna frequency adjustment structure), a bottom grounding structure 5, a first signal feeding structure 6 and a second signal feeding structure 7. By comparing FIG. 9 with FIG. 6, the main difference between the fourth embodiment and the second embodiment is as follows: in the fourth embodiment, the antenna layout carrying structure 1 can be configured as a stacked-type carrier substrate assembly.

More particularly, as shown in FIG. 9, when the antenna layout carrying structure 1 can be configured as the stacked-type carrier substrate assembly, the stacked-type carrier substrate assembly may at least include a first insulating carrier substrate 11, a second insulating carrier substrate 12, and an insulating adhesive layer 13 connected between the first insulating carrier substrate 11 and the second insulating carrier substrate 12. In addition, the second insulating carrier substrate 12 can be configured to cover the first insulating carrier substrate 11 through the insulating adhesive layer 13, so that an outer surrounding surface of the first insulating carrier substrate 11 can be covered by the second insulating carrier substrate 12. That is to say, according to different requirements, the antenna layout carrying structure 1 can be configured as a single insulating carrier substrate (as shown in the first and second embodiments), or a stacked-type carrier substrate assembly formed by at least stacking a first insulating carrier substrate 11 and a second insulating carrier substrate 12 (as shown in the fourth embodiment).

### Fifth Embodiment

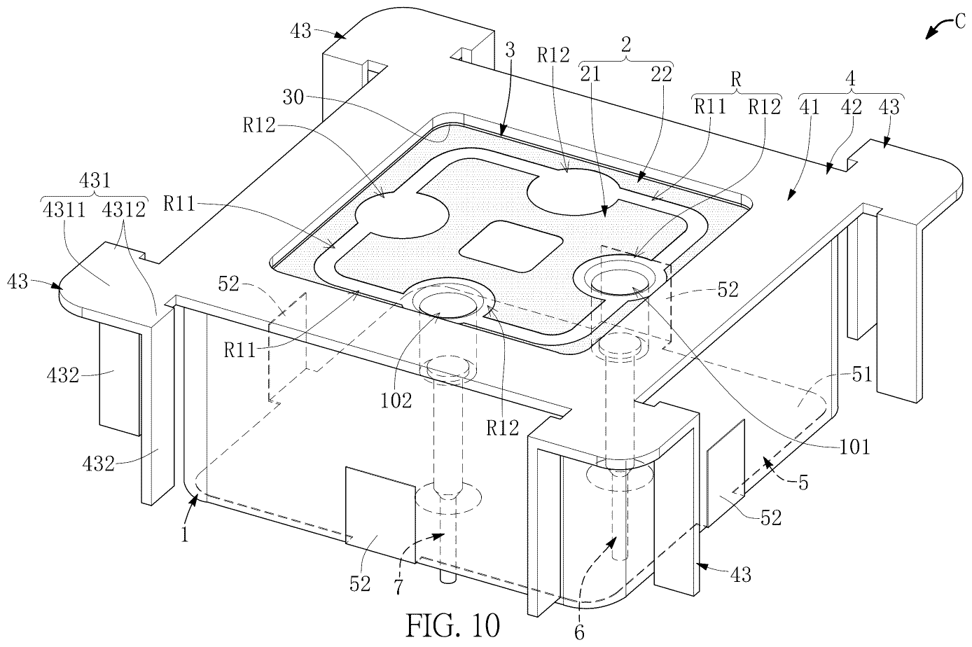

Referring to FIG. 10, a fifth embodiment of the present disclosure provides a patch antenna module C, which may include an antenna layout carrying structure 1, a planar antenna layout structure 2, an antenna positioning structure 3, an antenna frequency adjustment structure 4 (or a second antenna frequency adjustment structure), a bottom grounding structure 5, a first signal feeding structure 6 and a second signal feeding structure 7. By comparing FIG. 10 with FIG. 5, the main difference between the fifth embodiment and the second embodiment is as follows: in the fifth embodiment, the bottom grounding structure 5 may include a horizontally-extending structural layer 51 disposed on the bottom side of the antenna layout carrying structure 1 and a plurality of vertically-extending structural layers 52 vertically extending from the horizontally-extending structural layer 51 to an outer surrounding surface of the antenna layout carrying structure 1. Therefore, the antenna characteristics of the patch antenna module C provided by the present disclosure can be adjusted through the arrangement of the plurality of vertically-extending structural layers 52 of the bottom grounding structure 5.

### Sixth Embodiment

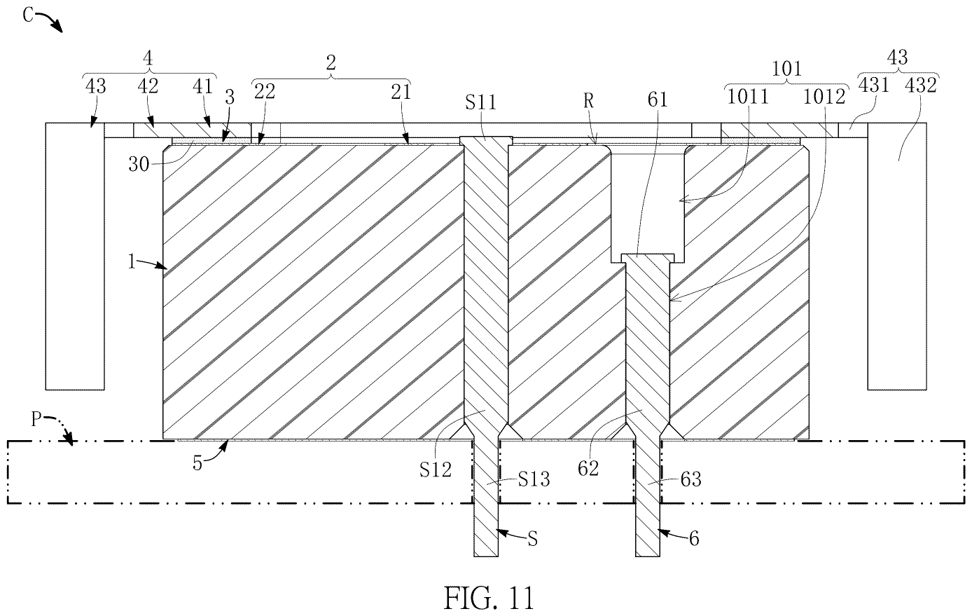

Referring to FIG. 11, a sixth embodiment of the present disclosure provides a patch antenna module C, which may include an antenna layout carrying structure 1, a planar antenna layout structure 2, an antenna positioning structure 3, an antenna frequency adjustment structure 4 (or a second antenna frequency adjustment structure), a bottom grounding structure 5, a first signal feeding structure 6 and a second signal feeding structure 7. By comparing FIG. 11 with FIG. 6, the main difference between the sixth embodiment and the second embodiment is as follows: in the sixth embodiment, the patch antenna module C may further include a structural reinforcement support member S, and the structural reinforcement support member S can pass through the antenna layout carrying structure 1, but cannot contact the inner surrounding antenna structure 21 and the outer surrounding antenna structure 22.

More particularly, as shown in FIG. 11, the structural reinforcement support member S may have a top position-limiting portion S11, an embedded extension portion S12 connected to the top position-limiting portion S11, and a bottom exposed portion S13 connected to the embedded extension portion S12. In addition, the top position-limiting portion S11 can be exposed on the top side of the antenna layout carrying structure 1, the embedded extension portion S12 can be embedded in the antenna layout carrying structure 1, and the bottom exposed portion S13 can be exposed from the bottom side of the antenna layout carrying structure 1. It should be noted that as shown in FIG. 11, when the patch antenna module C can be disposed on a circuit substrate P, the structural reinforcement support member S can be configured to be fixed on or connected to the circuit substrate P, thereby increasing the structural stability of the patch antenna module C that is disposed on the circuit substrate P.

### Seventh Embodiment

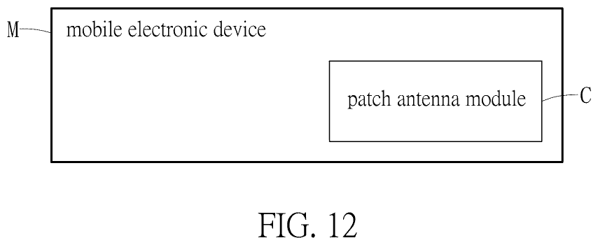

Referring to FIG. 12, a seventh embodiment of the present disclosure provides a mobile electronic device M (for example, any means of transportation such as motorcycles, cars, airplanes, ships, or any type of mobile vehicle), and the mobile electronic device M can be configured to use a patch antenna module C provided by the first to sixth embodiments of the present disclosure.

### Beneficial Effects of the Embodiments

In conclusion, in the patch antenna module C and the mobile electronic device M provided by the present disclosure, by virtue of “the planar antenna layout structure 2 being configured to be coplanarly disposed on the antenna layout carrying structure 1,” “the antenna positioning structure 3 being configured to partially cover the planar antenna layout structure 2,” “the antenna frequency adjustment structure 4 being configured to partially cover the planar antenna layout structure 2,” “the antenna frequency adjustment structure 4 being positioned on the planar antenna layout structure 2 through the antenna positioning structure 3” and “the antenna frequency adjustment structure 4 including an inner surrounding structure 41 disposed on the antenna positioning structure 3 and an outer surrounding structure 42 that is surroundingly connected to the inner surrounding structure 41 and separated from the antenna positioning structure 3,” the inner surrounding antenna structure 21 of the planar antenna layout structure 2 can be configured to be applied to a first antenna operating frequency band, and the outer surrounding antenna structure 22 of the planar antenna layout structure 2 can be configured to be applied to a second antenna operating frequency band.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A patch antenna module, comprising:
an antenna layout carrying structure;
a planar antenna layout structure, wherein the planar antenna layout structure is disposed on the antenna layout carrying structure;
an antenna positioning structure disposed on the planar antenna layout structure; and
an antenna frequency adjustment structure disposed on the antenna positioning structure;
wherein the planar antenna layout structure is configured to be coplanarly disposed on the antenna layout carrying structure;
wherein the antenna positioning structure is configured to partially cover the planar antenna layout structure;
wherein the antenna frequency adjustment structure is configured to partially cover the planar antenna layout structure;
wherein the antenna frequency adjustment structure is positioned on the planar antenna layout structure through the antenna positioning structure; and
wherein the antenna frequency adjustment structure includes an inner surrounding structure disposed on the antenna positioning structure and an outer surrounding structure being surroundingly connected to the inner surrounding structure and being separated from the antenna positioning structure.

2. The patch antenna module according to claim 1,
wherein a vertical projection of the inner surrounding structure of the antenna frequency adjustment structure completely falls on the antenna positioning structure and the planar antenna layout structure, so that a bottom side of the inner surrounding structure of the antenna frequency adjustment structure is completely covered;
wherein a vertical projection of the outer surrounding structure of the antenna frequency adjustment structure does not fall on the antenna positioning structure and the planar antenna layout structure, so that a bottom side of the outer surrounding structure of the antenna frequency adjustment structure is not covered and exposed outside;
wherein the antenna frequency adjustment structure further includes a plurality of outer extension structures extending outward from the outer surrounding structure and being separated from the antenna positioning structure;
wherein each of the outer extension structures includes a horizontal extension section extending horizontally outward from the outer surrounding structure and two vertical extension sections extending vertically downward from the horizontal extension section;
wherein a height of each of the vertical extension sections of each of the outer extension structures is less than a height of the antenna layout carrying structure, so that each of the vertical extension sections of each of the outer extension structures is in a suspended state;
wherein the antenna positioning structure is configured as a conductive adhesive layer between the inner surrounding structure and the planar antenna layout structure, and the antenna frequency adjustment structure is configured as a top metal cover plate located at a top position of the patch antenna module; and
wherein the horizontal extension section of each of the outer extension structures has a horizontal main extension portion connected to a corner of the outer surrounding structure and two horizontal auxiliary extension portions extending from two opposite sides of the horizontal main extension portion respectively, and the two vertical extension sections of each of the outer extension structures extend vertically downward from the two horizontal auxiliary extension portions of a corresponding one of the horizontal extension sections respectively.

3. The patch antenna module according to claim 1,
wherein the planar antenna layout structure includes an inner surrounding antenna structure and an outer surrounding antenna structure, the inner surrounding antenna structure and the outer surrounding antenna structure are coplanarly disposed on a top side of the antenna layout carrying structure, and the inner surrounding antenna structure is surrounded by the outer surrounding antenna structure;
wherein the patch antenna module further comprises a bottom grounding structure, and the bottom grounding structure is disposed on a bottom side of the antenna layout carrying structure;
wherein the patch antenna module further comprises a first signal feeding structure, the first signal feeding structure is disposed on the antenna layout carrying structure and passes through the antenna layout carrying structure, and the first signal feeding structure is located between the inner surrounding antenna structure and the outer surrounding antenna structure and is separated from the bottom grounding structure;
wherein a surrounding non-antenna area is formed between the inner surrounding antenna structure and the outer surrounding antenna structure to separate the inner surrounding antenna structure and the outer surrounding antenna structure from each other and to partially expose an upper surface of the antenna layout carrying structure;
wherein the antenna layout carrying structure has a first through hole, a portion of the first signal feeding structure is embedded in the first through hole of the antenna layout carrying structure, and another portion of the first signal feeding structure is exposed outside the first through hole of the antenna layout carrying structure; and
wherein the inner surrounding antenna structure is configured to be applied to a first antenna operating frequency band, the outer surrounding antenna structure is configured to be applied to a second antenna operating frequency band, and the first antenna operating frequency band is greater than the second antenna operating frequency band.

4. The patch antenna module according to claim 3,
wherein the antenna layout carrying structure is configured as a single insulating carrier substrate integrally formed or a stacked-type carrier substrate assembly formed by stacking at least two insulating carrier substrates;
wherein, when the antenna layout carrying structure is configured as the stacked-type carrier substrate assembly, the stacked-type carrier substrate assembly includes a first insulating carrier substrate, a second insulating carrier substrate, and an insulating adhesive layer connected between the first insulating carrier substrate and the second insulating carrier substrate, and an outer surrounding surface of the first insulating carrier substrate is exposed outside the second insulating carrier substrate or covered by the second insulating carrier substrate;
wherein a central penetration portion of the antenna layout carrying structure is configured as a solid portion or a hollow portion;
wherein the surrounding non-antenna area has at least one unoccupied line area and at least one unoccupied opening area connected to the at least one unoccupied line area, and a diameter of the at least one unoccupied opening area is greater than a width of the at least one unoccupied line area;
wherein the bottom grounding structure includes a horizontally-extending structural layer disposed on the bottom side of the antenna layout carrying structure and a plurality of vertically-extending structural layers vertically extending from the horizontally-extending structural layer to an outer surrounding surface of the antenna layout carrying structure;
wherein the patch antenna module further includes a structural reinforcement support member, the structural reinforcement support member passes through the antenna layout carrying structure, and the structural reinforcement support member has a top position-limiting portion exposed on the top side of the antenna layout carrying structure, an embedded extension portion connected to the top position-limiting portion and embedded in the antenna layout carrying structure, and a bottom exposed portion connected to the embedded extension portion and exposed from the bottom side of the antenna layout carrying structure; and
wherein, when the patch antenna module is disposed on a circuit substrate, the structural reinforcement support member is configured to be connected to the circuit substrate, thereby increasing the structural stability of the patch antenna module that is disposed on the circuit substrate.

5. The patch antenna module according to claim 3,
wherein the first through hole of the antenna layout carrying structure has a first top through-hole portion and a first bottom through-hole portion communicated with the first top through-hole portion, and an aperture of the first top through-hole portion is larger than an aperture of the first bottom through-hole portion;
wherein the first signal feeding structure includes a first top position-limiting portion disposed inside the first top through-hole portion, a first embedded extension portion connected to the first top position-limiting portion and disposed inside the first bottom through-hole portion, and a first bottom exposed portion connected to the first embedded extension portion and exposed outside the first bottom through-hole portion, and a first vertical distance between the first top position-limiting portion of the first signal feeding structure and the inner surrounding antenna structure or the outer surrounding antenna structure is greater than a first horizontal distance between the first top position-limiting portion of the first signal feeding structure and the inner surrounding antenna structure or the outer surrounding antenna structure;
wherein the patch antenna module further includes a second signal feeding structure, the second signal feeding structure is disposed on the antenna layout carrying structure and passes through the antenna layout carrying structure, and the second signal feeding structure is located between the inner surrounding antenna structure and the outer surrounding antenna structure and is separated from the bottom grounding structure;
wherein the antenna layout carrying structure has a second through hole, a portion of the second signal feeding structure is embedded in the second through hole of the antenna layout carrying structure, and another portion of the second signal feeding structure is exposed outside the second through hole of the antenna layout carrying structure;
wherein the second through hole of the antenna layout carrying structure has a second top through-hole portion and a second bottom through-hole portion communicated with the second top through-hole portion, and an aperture of the second top through-hole portion is larger than an aperture of the second bottom through-hole portion;
wherein the second signal feeding structure includes a second top position-limiting portion disposed inside the second top through-hole portion, a second embedded extension portion connected to the second top position-limiting portion and disposed inside the second bottom through-hole portion, and a second bottom exposed portion connected to the second embedded extension portion and exposed outside the second bottom through-hole portion, and a second vertical distance between the second top position-limiting portion of the second signal feeding structure and the inner surrounding antenna structure or the outer surrounding antenna structure is greater than a second horizontal distance between the second top position-limiting portion of the second signal feeding structure and the inner surrounding antenna structure or the outer surrounding antenna structure; and
wherein, relative to a central penetration portion of the antenna layout carrying structure, the first signal feeding structure and the second signal feeding structure are arranged at an angle of 90 degrees from each other.

6. A mobile electronic device configured to use a patch antenna module, wherein the patch antenna module comprises:
an antenna layout carrying structure;
a planar antenna layout structure, wherein the planar antenna layout structure is disposed on the antenna layout carrying structure;
an antenna positioning structure disposed on the planar antenna layout structure; and
an antenna frequency adjustment structure disposed on the antenna positioning structure;
wherein the planar antenna layout structure is configured to be coplanarly disposed on the antenna layout carrying structure;
wherein the antenna positioning structure is configured to partially cover the planar antenna layout structure;
wherein the antenna frequency adjustment structure is configured to partially cover the planar antenna layout structure;
wherein the antenna frequency adjustment structure is positioned on the planar antenna layout structure through the antenna positioning structure; and
wherein the antenna frequency adjustment structure includes an inner surrounding structure disposed on the antenna positioning structure and an outer surrounding structure being surroundingly connected to the inner surrounding structure and being separated from the antenna positioning structure.

7. The mobile electronic device according to claim 6,
wherein a vertical projection of the inner surrounding structure of the antenna frequency adjustment structure completely falls on the antenna positioning structure and the planar antenna layout structure, so that a bottom side of the inner surrounding structure of the antenna frequency adjustment structure is completely covered;
wherein a vertical projection of the outer surrounding structure of the antenna frequency adjustment structure does not fall on the antenna positioning structure and the planar antenna layout structure, so that a bottom side of the outer surrounding structure of the antenna frequency adjustment structure is not covered and exposed outside;
wherein the antenna frequency adjustment structure further includes a plurality of outer extension structures extending outward from the outer surrounding structure and being separated from the antenna positioning structure;
wherein each of the outer extension structures includes a horizontal extension section extending horizontally outward from the outer surrounding structure and two vertical extension sections extending vertically downward from the horizontal extension section;
wherein a height of each of the vertical extension sections of each of the outer extension structures is less than a height of the antenna layout carrying structure, so that each of the vertical extension sections of each of the outer extension structures is in a suspended state;
wherein the antenna positioning structure is configured as a conductive adhesive layer between the inner surrounding structure and the planar antenna layout structure, and the antenna frequency adjustment structure is configured as a top metal cover plate located at a top position of the patch antenna module; and
wherein the horizontal extension section of each of the outer extension structures has a horizontal main extension portion connected to a corner of the outer surrounding structure and two horizontal auxiliary extension portions extending from two opposite sides of the horizontal main extension portion respectively, and the two vertical extension sections of each of the outer extension structures extend vertically downward from the two horizontal auxiliary extension portions of a corresponding one of the horizontal extension sections respectively.

8. The mobile electronic device according to claim 6,
wherein the planar antenna layout structure includes an inner surrounding antenna structure and an outer surrounding antenna structure, the inner surrounding antenna structure and the outer surrounding antenna structure are coplanarly disposed on a top side of the antenna layout carrying structure, and the inner surrounding antenna structure is surrounded by the outer surrounding antenna structure;
wherein the patch antenna module further comprises a bottom grounding structure, and the bottom grounding structure is disposed on a bottom side of the antenna layout carrying structure;
wherein the patch antenna module further comprises a first signal feeding structure, the first signal feeding structure is disposed on the antenna layout carrying structure and passes through the antenna layout carrying structure, and the first signal feeding structure is located between the inner surrounding antenna structure and the outer surrounding antenna structure and is separated from the bottom grounding structure;
wherein a surrounding non-antenna area is formed between the inner surrounding antenna structure and the outer surrounding antenna structure to separate the inner surrounding antenna structure and the outer surrounding antenna structure from each other and to partially expose an upper surface of the antenna layout carrying structure;
wherein the antenna layout carrying structure has a first through hole, a portion of the first signal feeding structure is embedded in the first through hole of the antenna layout carrying structure, and another portion of the first signal feeding structure is exposed outside the first through hole of the antenna layout carrying structure; and
wherein the inner surrounding antenna structure is configured to be applied to a first antenna operating frequency band, the outer surrounding antenna structure is configured to be applied to a second antenna operating frequency band, and the first antenna operating frequency band is greater than the second antenna operating frequency band.

9. The mobile electronic device according to claim 8,
wherein the antenna layout carrying structure is configured as a single insulating carrier substrate integrally formed or a stacked-type carrier substrate assembly formed by stacking at least two insulating carrier substrates;
wherein, when the antenna layout carrying structure is configured as the stacked-type carrier substrate assembly, the stacked-type carrier substrate assembly includes a first insulating carrier substrate, a second insulating carrier substrate, and an insulating adhesive layer connected between the first insulating carrier substrate and the second insulating carrier substrate, and an outer surrounding surface of the first insulating carrier substrate is exposed outside the second insulating carrier substrate or covered by the second insulating carrier substrate;
wherein a central penetration portion of the antenna layout carrying structure is configured as a solid portion or a hollow portion;
wherein the surrounding non-antenna area has at least one unoccupied line area and at least one unoccupied opening area connected to the at least one unoccupied line area, and a diameter of the at least one unoccupied opening area is greater than a width of the at least one unoccupied line area;
wherein the bottom grounding structure includes a horizontally-extending structural layer disposed on the bottom side of the antenna layout carrying structure and a plurality of vertically-extending structural layers vertically extending from the horizontally-extending structural layer to an outer surrounding surface of the antenna layout carrying structure;
wherein the patch antenna module further includes a structural reinforcement support member, the structural reinforcement support member passes through the antenna layout carrying structure, and the structural reinforcement support member has a top position-limiting portion exposed on the top side of the antenna layout carrying structure, an embedded extension portion connected to the top position-limiting portion and embedded in the antenna layout carrying structure, and a bottom exposed portion connected to the embedded extension portion and exposed from the bottom side of the antenna layout carrying structure; and
wherein, when the patch antenna module is disposed on a circuit substrate, the structural reinforcement support member is configured to be connected to the circuit substrate, thereby increasing the structural stability of the patch antenna module that is disposed on the circuit substrate.

10. The mobile electronic device according to claim 8,
wherein the first through hole of the antenna layout carrying structure has a first top through-hole portion and a first bottom through-hole portion communicated with the first top through-hole portion, and an aperture of the first top through-hole portion is larger than an aperture of the first bottom through-hole portion;
wherein the first signal feeding structure includes a first top position-limiting portion disposed inside the first top through-hole portion, a first embedded extension portion connected to the first top position-limiting portion and disposed inside the first bottom through-hole portion, and a first bottom exposed portion connected to the first embedded extension portion and exposed outside the first bottom through-hole portion, and a first vertical distance between the first top position-limiting portion of the first signal feeding structure and the inner surrounding antenna structure or the outer surrounding antenna structure is greater than a first horizontal distance between the first top position-limiting portion of the first signal feeding structure and the inner surrounding antenna structure or the outer surrounding antenna structure;
wherein the patch antenna module further includes a second signal feeding structure, the second signal feeding structure is disposed on the antenna layout carrying structure and passes through the antenna layout carrying structure, and the second signal feeding structure is located between the inner surrounding antenna structure and the outer surrounding antenna structure and is separated from the bottom grounding structure;
wherein the antenna layout carrying structure has a second through hole, a portion of the second signal feeding structure is embedded in the second through hole of the antenna layout carrying structure, and another portion of the second signal feeding structure is exposed outside the second through hole of the antenna layout carrying structure;
wherein the second through hole of the antenna layout carrying structure has a second top through-hole portion and a second bottom through-hole portion communicated with the second top through-hole portion, and an aperture of the second top through-hole portion is larger than an aperture of the second bottom through-hole portion;
wherein the second signal feeding structure includes a second top position-limiting portion disposed inside the second top through-hole portion, a second embedded extension portion connected to the second top position-limiting portion and disposed inside the second bottom through-hole portion, and a second bottom exposed portion connected to the second embedded extension portion and exposed outside the second bottom through-hole portion, and a second vertical distance between the second top position-limiting portion of the second signal feeding structure and the inner surrounding antenna structure or the outer surrounding antenna structure is greater than a second horizontal distance between the second top position-limiting portion of the second signal feeding structure and the inner surrounding antenna structure or the outer surrounding antenna structure; and
wherein, relative to a central penetration portion of the antenna layout carrying structure, the first signal feeding structure and the second signal feeding structure are arranged at an angle of 90 degrees from each other.
